(19) United States
(12) Patent Application Publication
(10) Pub. No.: US 2026/0111899 A1
(43) Pub. Date: Apr. 23, 2026

(54) SYSTEMS AND METHODS TO FACILITATE ELECTRONIC PAYMENT CONFIRMATION

(71) Applicant: TBCASOFT, INC., Sunnyvale, CA (US)

(72) Inventors: Brian M CHAN, Johns Creek, GA (US); Shieng-Chyuarn JANG, Newark, CA (US); Simon MA, Mountain View, CA (US); Dennis WONG, Fremont, CA (US)

(21) Appl. No.: 19/117,059

(22) PCT Filed: Oct. 2, 2023
(86) PCT No.: PCT/IB2023/000612

§ 371 Date: Mar. 30, 2025

Related U.S. Application Data
(60) Provisional application No. 63/378,048, filed on Sep. 30, 2022.

(51) Int. Cl. G06Q 20/42; G06Q 20/32

(52) U.S. Cl. CPC G06Q 20/42; G06Q 20/3274; G06Q 20/3276

(57) ABSTRACT

The present invention relates to a system and method to facilitate electronic payment confirmation by generating a second confirmation page (SCP) of a second service provider different from a first confirmation page (FCP) of a first service provider in a bridging transaction. In this method, a bridging system of a service provider provides the content of the SCP for a payer of the first service provider to generate the SCP. The generated SCP then may be presented to a receiver of the second service provider to the receiver's confirmation.

### BACKGROUND OF THE INVENTION

### Related Application

This application claims the benefit of the U.S. Provisional Application No. 63/378,048 filed on Sep. 30, 2022, titled “SYSTEMS AND METHODS TO FACILITATE ELECTRONIC PAYMENT CONFIRMATION,” which is incorporated herein by reference at its entirety.

### Field of the Invention

The present invention relates to a system and method to facilitate electronic payment confirmation, especially for QR-code payments between a payer of a service provider and a receiver of a different service provider.

### Description of Related Art

QR code payment is a contactless payment method performed by scanning a QR code from a mobile app or from a merchant point of sale (POS) system. There are two types of QR code payment methods, merchant presented mode (MPM) and consumer presented mode (CPM), which are different in the party who presents the QR code for the counterparty to scan. In merchant presented mode (MPM), the consumer scans the QR code displayed by the merchant with their smartphone to pay. On the contrary, in consumer presented mode (CPM), the merchant scans the QR code displayed by the consumer to receive the payment. With QR code payment, a transaction can be done even without the infrastructure traditionally associated with electronic payments, such as payment cards, payment networks, payment terminal and merchant accounts.

However, the above situation only applies when the consumer and the merchant having accounts belong to the same electronic payment system provider (service provider). In the case that the payment accounts of the consumer and the merchant belong to different service providers, a transaction between the consumer and the merchant is not possible. To enable the transaction, a bridging service provider that connects the two service providers is required, and a bridged transaction is carried out between the consumer and the merchant. The term “bridge” or “bridging” describe the system or the method that enables a payer of a first service provider to present a target (e.g., a QR code) of a second service provider to a receiver of the second service provider, who does not recognize a target (e.g., a QR code) of the first service provider, so that a transaction between the payer and the receiver can be completed. The details of bridging technologies used in bridged transactions are described in PCT International Patent Publication Nos. WO2021/211773 and WO2023/132995. In short, the bridging technologies employ a bridging service provider as a “bridge” between different service providers in the bridging network, and enable a payer of any service provider to (1) recognize a target (e.g., a QR code) presented by a receiver of any other service provider, or (2) present a target (e.g., a QR code) recognizable by the device (e.g. POS) of the receiver. In such, a QR code transaction can be performed between different service providers without changing the existing infrastructure of merchants. The only thing required is to update the software in the mobile phone of the payer to enable bridged transactions. If the payer is a user of the first service provider, after transaction the payer will receive a confirmation page with the format of the first service provider, which performs identically to the transactions within the payment network of the first service provider.

However, there are occasions that the payer is required to show a confirmation page of the receiver's service provider. For example, if the payer wants to return the goods and request a refund, he/she might need to show the confirmation page to the merchant so that the merchant can identify the exact transaction. Presenting a confirmation page with the format the merchant familiar to is much more convenient in communication. There are other examples where the payer might be required to show a confirmation page of the receiver's service provider. In some cases of MPM transaction, the merchant has a fixed code for payment collection, and a transaction is usually confirmed by the consumer showing the confirmation page to the merchant. If the above-mentioned transaction is a bridged transaction, the merchant might suffer from not recognizing the confirmation page shown by the consumer, since the consumer uses the service from another service provider, and the confirmation page is with another format and even in another language.

### SUMMARY OF THE INVENTION

In this invention, the “Dual Confirmation Page” (DCP) technology is provided to address the above issue. DCP technology enables a user of one service provider to provide a confirmation page with the format of another service provider. The confirmation page of another service provider may be shown to the merchant, thereby solving the problem encountered by the merchant as described above.

One aspect the present application provides a method to generate a second confirmation page (SCP) of a second service provider different from a first confirmation page (FCP) of a first service provider for a bridging transaction between a payer of the first service provider and a receiver of the second service provider. The method comprising: (1) receiving, by a bridging system of a bridging service provider, a second confirmation page (SCP) request containing a transaction identifier, from a first management system of the first service provider; (2) searching, by the bridging system, a transaction database for a transaction information corresponding to the transaction identifier; (3) generating, by the bridging system, an SCP content file containing page layout information for SCP generation; and (4) providing, by the bridging system, the SCP content file to the first management system. In this method, the first service provider is different from the bridging service provider and the second service provider. In one embodiment, the transaction identifier is an identifier recognizable to the bridging system which uniquely identifies the transaction between the payer and the receiver.

The method may further comprise steps of: (1) identifying, by the bridging service provider, the second service provider from multiple acquirers based on the transaction information; and (2) generating, by the bridging service provider, the SCP content file of the second service provider. In one embodiment, The SCP content file comprises a text content and an image reference content. In a preferred embodiment, the SCP content file comprises an HTML file for generating the SCP. In one embodiment, the image reference content provides a URL to access the SCP image content, and the SCP image content is provided from an image database storing image contents of the multiple acquirers.

After providing the SCP content file to the first management system, the method may further comprise: (1) receiving, by the bridging service provider, an image request for an SCP image content from a portable device of the payer based on the SCP content file; and (2) providing, by the bridging service provider, the SCP image content to the portable device of the payer.

In one embodiment, the transaction database stores transaction information for transactions between the first service provider and the multiple acquirers. The transaction information corresponding to the transaction identifier may comprise a name of the receiver, a transaction number, a transaction time, a transaction currency and a transaction amount.

In a preferred embodiment, the generated second confirmation page (SCP) is displayed on the portable device with the first confirmation page (FCP) generated by the first management system to form dual confirmation page (DCP). The dual confirmation page (DCP) may have a tab to switch between the first confirmation page (FCP) and the second confirmation page (SCP).

Another aspect the present application provides a system for generating a second confirmation page (SCP) of a second service provider different from a first confirmation page (FCP) of a first service provider for a bridging transaction between the first service provider and the second service provider which is one of multiple acquirers, comprising (1) a transaction database, (2) an image database and (3) a view maker. The transaction database is configured to store information of bridging transactions between the first service provider and the multiple acquirers; the image database is configured to store image contents for confirmation pages of the multiple acquirers; and the view maker communicatively connects to the transaction database, and is configured to communicatively connect to a first management system of the first service provider. The view maker also comprises instructions stored thereon configured to, in response to execution of the instructions, perform operations comprising: (1) receiving a second confirmation page (SCP) request containing a transaction identifier, from a first management system of the first service provider; (2) searching the transaction database for a transaction information corresponding to the transaction identifier; (3) generating an SCP content file containing page layout information for SCP generation based on the transaction information; and (4) providing the SCP content file to the first management system. The second service provider configured to connect with the system is different from the first service provider.

In one embodiment, the image database is configured to: (1) receive an image request for an SCP image content from the first management system based on the SCP content file; and (2) providing the SCP image content to the first management system. In one embodiment, the view maker is configured to communicatively connect to multiple issuers, one of which is the first management system of the first service provider.

Other objectives, advantages and novel features of the invention will become more apparent from the following detailed description when taken in conjunction with the accompanying drawings.

### BRIEF DESCRIPTION OF THE DRAWINGS

FIG. 1 shows the system implementing bridging transaction.

FIG. 2 shows the system and method implementing the Dual Confirmation Page (DCP) technology.)

FIG. 3-FIG. 7 is an example showing the user wire-flow of an app performing DCP. FIG. 3 shows the steps from starting to “selecting payment mode”. In this example, Pi Wallet is the first service provider, and PayPay is selected as the second service provider. The “HIVEX API” Logo in this figure means that the bridging service provider is involved in this step.

FIG. 4 shows the steps from “selecting MPM as payment mode” to “sending a payment confirmation to the bridging service provider” in merchant presented mode (MPM) bridging transaction. The “HIVEX API” Logo in this figure means that the bridging service provider is involved in this step.

FIG. 5 shows the steps from “selecting CPM as payment mode” to “merchant scanning process” in consumer presented mode (CPM) bridging transaction. The “HIVEX API” Logo in this figure means that the bridging service provider is involved in this step.

FIG. 6 shows the dual confirmation page (DCP) when the transaction is failed. On the left side is the second confirmation page in the format of the second service provider (PayPay), and on the right side is the first confirmation page in the format of the first service provider (Pi Wallet).

FIG. 7 shows the dual confirmation page (DCP) when the transaction is successful. On the left side is the second confirmation page in the format of the second service provider (PayPay), and on the right side is the first confirmation page in the format of the first service provider (Pi Wallet).

### DETAILED DESCRIPTION OF PREFERRED EMBODIMENTS

The terminology used in the description presented below is intended to be interpreted in its broadest reasonable manner, even though it is used in conjunction with a detailed description of certain specific embodiments of the technology. Certain terms may even be emphasized below; however, any terminology intended to be interpreted in any restricted manner will be specifically defined as such in this Detailed Description section.

The embodiments introduced below can be implemented by programmable circuitry programmed or configured by software and/or firmware, or entirely by special-purpose circuitry, or in a combination of such forms. Such special-purpose circuitry (if any) can be in the form of, for example, one or more application-specific integrated circuits (ASICs), programmable logic devices (PLDs), field-programmable gate arrays (FPGAs), graphics processing units (GPUs), etc.

This application provides a method and a system for a portable device (e.g., a mobile phone) of a first service provider to provide a transaction confirmation page of a second service provider (a second confirmation page), wherein the first service provider is different from the second service provider, and the second confirmation page may be displayed on the screen of the portable device. In the specification, the confirmation page of a first service provider is called a first confirmation page, and the confirmation page of a second service provider is called a second confirmation page. The method enables a second confirmation page (SCP) generation besides a first confirmation page (FCP), and the two pages are collectively called “dual confirmation page (DCP)”. The method is useful in a merchant presented mode (MPM) bridging QR-code transaction, especially when the receiver (e.g., a merchant) does not have a POS system to immediately check the transaction results (and thus can only rely on the confirmation page presented by the payer on his/her portable device).

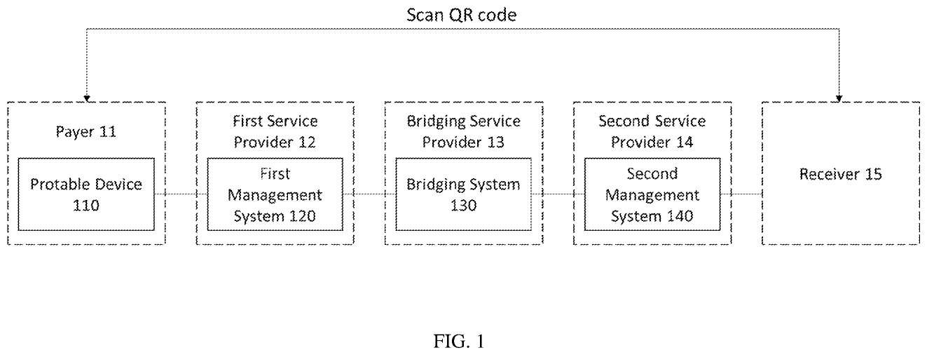

Referring to FIG. 1, in a bridging QR-code transaction, the consumer usually acts as a payer 11, and the merchant usually acts as a receiver 15. Here we assume that the payer 11 is a user of the first service provider 12, and the receiver 15 is a user of the second service provider 14.

In a merchant presented mode (MPM) bridging QR-code transaction, the receiver 15 (the merchant) first presents a receiving QR code of the second service provider 14. The payer 11 (e.g., the consumer) scans the QR code by a portable device 110, transmits the QR code content to a first management system 120 of the first service provider 12. The first management system 120 then relays the QR code content to the bridging system 130 of the bridging service provider 13. The bridging system 130 then transmits the QR code content along with the identity information of the payer 11 to a second management system 140 of the second service provider 14. Upon receiving the request from the payer 11, the second management system 140 returns receiver identity information via the bridging system 130 and first management system 120 to the portable device 110 of the payer 11. The payer 11 then can enter the amount to be transferred and confirm the payment by returning a confirmation to the first management system 120, the bridging system 130 and the second management system 140 to conduct a payment. Alternatively, some QR codes presented by the receiver 15 may contain payment currency and amount. In this case, the payer 11 only needs to confirm the payment and needs not to enter the amount to be transferred in the returned confirmation.

In a consumer presented mode (CPM) bridging QR-code transaction, the payer 11 (the consumer) needs to request a QR-code in the format of the second service provider to conduct a CPM bridging transaction. First the payer 11 request a paying QR code of the second service provider 14. The first management system 120 of the first service provider 12 receives the request and relay the request to the bridging system 130 of the bridging service provider 13. The bridging system 130 then returns a bridging paying QR code to the portable device 110 via the first management system 120. The details of requesting and returning bridging QR codes used in bridged transactions are described in PCT International Patent Publication No. WO2023/132995 and is incorporated herein by reference at its entirety. The payer 11 shows the bridging paying QR code on the portable device 110 and the receiver 15 scans it by a merchant device. The merchant device then transmits the QR code content to the second management system 140 of the second service provider 14, and the second management system 140 relays the QR code content to the bridging system 130 of the bridging service provider 13. Depending on the settings of the system, the bridging system 130 may proceed with the bridging transaction directly or request a confirmation by the payer 11 first. Then the bridging system 130 will execute the transaction and push a notification notifying the transaction result to both the payer 11 (via the first management system 120) and the receiver 15 (via the second management system 140).

In this network, the bridging service provider 13 acts as a “bridge” to link the payment systems of the first service provider 12 and the second service provider 14. More generally, in a bridging network comprising many service providers, the bridging service provider 13 acts as a “bridge” to link any of the two service providers which conduct a bridging transaction.

In one embodiment, the portable device 110 (e.g., a mobile phone of the payer 11) requests an information of the bridging transaction and the image/text data of the second service provider 14 after receiving a notification confirming success of the bridging transaction. As described above, the second service provider 14 is the service provider used by the receiver 15 to accept payments, and the second service provider 14 is different from the first service provider 12, which is used by the payer 11 to transfer payments. The program installed in the portable device 110 may request the information of the bridging transaction (such as the name of the receiver, the time, the transaction number, currency and amount) and the image/text data (such as the images and the text shown on the confirmation page) of the second service provider 14 from the bridging network, and combine them to produce a second confirmation page for the transaction in format of the second service provider 14. For example, the program in the portable device 110 may request the essential transaction information and the image/text data from the first management system 120 of the first service provider 12, or the bridging system 130 of the bridging service provider 13.

In another embodiment, the program installed in the portable device 110 (e.g. a mobile phone of the payer 11) gets access to the information of the bridging transaction during the process of bridging transaction. For example, in MPM, upon QR scanning, the portable device 110 of the payer 11 will initiate a payment transaction and relay the request via a portable device 110-first management system 120-bridging system 130-second management system 140 route. The second management system 140 will then send the name of the receiver 15 back to the payer 11 via a reversed route, i.e., second management system 140-bridging system 130-first management system 120-portable device 110. Depending on the content of the QR code, the second management system 140 may also transmit the transaction amount/currency to be confirmed by the payer 11, or the second management system 140 may transmit receiver information without specifying the transaction amount and leave it blank for the payer 11 to fill in. In both cases, the portable device 110 of the payer 11 may collect the information such as the identity of the second service provider 14, the name of the receiver 15, and the amount/currency to be transferred in this bridging transaction. Similarly, in CPM, the portable device 110 may be able to collect the transaction information during scanning and confirmation steps. The image/text data of the second service provider 14 may be requested from the network (e.g., a content delivery network), or it may also be pre-stored in the app for second confirmation page production. Then the program in the portable device 110 may combine the transaction information and the image/text data to produce a second confirmation page in format of the second service provider 14.

In a preferred embodiment, the program in the portable device 110 may directly request the intact content of the second confirmation page, instead of requesting transaction information and the image/text data separately and combining them together subsequently. The intact content of the second confirmation page may be provided by the bridging service provider 13, which serves as the “bridge” to link the payer of the first service provider 12 and the receiver of the second service provider 14. A bridging system 130 of the bridging service provider 13 may record information of bridging transactions on its database, and may store image and text data of all participating service providers. Upon request, the bridging system 130 of the bridging service provider 13 then may provide the transaction information (e.g., receiver name, transaction amount/currency) and the image/text data of the second service provider's confirmation page. The above information/data may be provided together as the form of an intact confirmation page in format of the second service provider 14 (a second confirmation page). In one example, the information for the second confirmation page may be provided in the form of a markup language such as an HTML file. The HTML file may contain text message of the confirmation page and the links for image contents. The portable device 110 then may generate the intact confirmation page based on the HTML file, and show the second confirmation page on the screen of the portable device. Alternatively, the intact content of a second confirmation page may be provided as an image as a whole, such as provided as a JPG file.

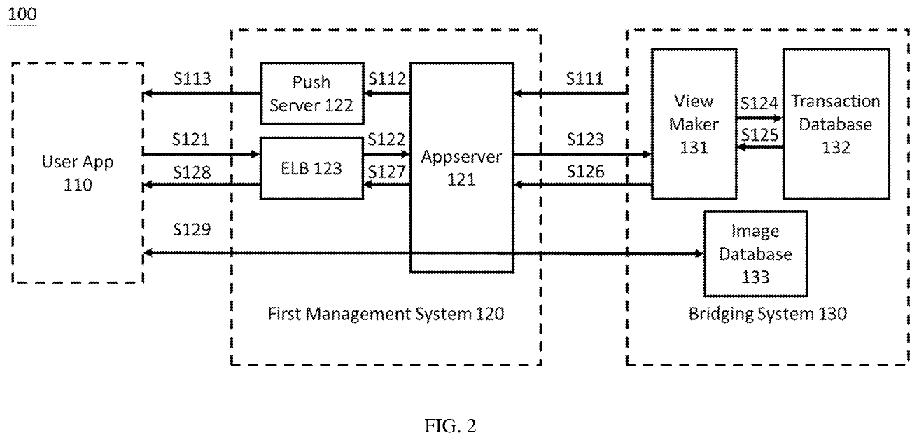

Regarding the system performing DCP generation, in an embodiment the system comprises a first management system 120 of a first service provider 12, a bridging system 130 of a bridging service provider 13, and a portable device 110 of a payer 11. In addition, a second management system 140 of a second service provider 14 is usually included, too. In this system, the first management system 120 is communicatively connected to both the portable device 110 and the bridging system 130. The second management system 140 is also communicatively connected to the bridging system 130. The system configuration of the present invention is as shown in FIG. 1 and FIG. 2. This configuration enables a bridging transaction between a payer 11 of the first service provider and a receiver 15 of the second service provider. In addition, if the essential information is provided, this configuration also enables DCP generation following the bridging transaction. For details of bridging transaction, PCT International Patent Publication Nos. WO2021/211773 and WO2023/132995 are hereby incorporated fully by reference. In brief, the bridging service provider 130 act as a “bridge” between a payer 11 of the first service provider 12 and a receiver 15 of the second service provider 14 to facilitate the transaction between the two parties. After a bridging transaction is processed and confirmed, the bridging system 130 of the bridging service provider 13 (e.g., HIVEX as shown in FIG. 2) pushes a notification via the first management system 120 of the first service provider 12 to the portable device 110 of the payer 11, as described in steps S111, S112 and S113 in FIG. 2.

For DCP generation, a confirmation page with the format of the first service provider (first confirmation page) can be generated after receiving the notification, and displayed on the screen of the portable device 110, as normally performed in a transaction within the network of the first service provider 12. The confirmation page usually contains transaction information such as name of the receiver, transaction number, transaction time, transaction currency and transaction amount. This confirmation page generated with the format of the first service provider may be presented by the payer 11 to the receiver 15 as a confirmation of the payment.

For the payer 11 to generate a confirmation page in the format of the second service provider (second confirmation page), the portable device 110 of the payer 11 will request essential information to generate a new confirmation page. The essential information may include the transaction information and the image/text format of the second service provider. In the case of a bridging transaction, the bridging system 130 of the bridging service provider 13 may have a database recording transactions involving different service providers bridged by the bridging service provider 13, such as a transaction between the payer 11 of the first service provider 12 and the receiver 15 of the second service provider 14. Normally, the first service provider 12 and/or the second service provider 14 also have their own databases to store data of processed bridging transactions. The transaction information may be retrieved from the database of the first service provider 12 or the bridging service provider 13, and sent by the first management system 120 of the first service provider 12 to the portable device 110. The image/text format of the second service provider 14 may be acquired from the whole bridging network, including the first service provider 12, the second service provider 14 and/or the bridging service provider 13. In one embodiment, the image and text format of the second service provider 14 is acquired from the bridging system 130 of the bridging service provider 13.

A computer program (e.g. an app) in the portable device 110 may collect the transaction information and the image/text format of the second service provider 14, and integrate the above information to generate a second confirmation page of the second service provider 14. Alternatively, in the case where the first management system 120 or the bridging system 130 has integrated the contents of the second confirmation page together, the portable device may simply receive the data without integration.

### Flow Chart of Second Confirmation Page (SCP) Generation

An example of a system performing SCP generation is shown in FIG. 2. The system 100 comprises a first management system 120 of a first service provider, a bridging system 130 of a bridging service provider, and a portable device 110 of a payer. The first management system 120 of the first service provider (or the “Issuer”) is communicatively connected to the bridging system 130 of the bridging service provider (or “HIVEX”). The first management system 120 may comprise an Appserver 121, a push server 122, and an elastic load balancer (ELB) 123 to perform SCP generation-related functions. The Appserver 121 may be a virtual machine (VM) on the cloud (e.g., Amazon Web Services (AWS)) configured to perform bridging-transaction-related tasks of the first management system 120, such as a system interface to the bridging system 130. The functions of the Appserver 121 may include but not limited to handling incoming requests/notifications and/or redirecting the requests/notifications to the correct destinations. For example, the Appserver 121 may redirect a transaction notification from the bridging system 130 to the portable device 110 of the correct payer 11 based on a user identifier, or may redirect a SCP request from the portable device 110 to the bridging system 130. The push server 122 may be a logically isolated virtual network on the cloud (e.g., Amazon Virtual Private Cloud) configured to relay transaction messages and notifications from the Appserver 121 to the portable device 110 of the payer 11. The elastic load balancer 123 may be an online service to distribute network traffic to improve application scalability, such as the service provided by AWS, which is configured to receive requests from the portable device 110 to the Appserver 121. The bridging system 130 of the bridging service provider may comprise a view maker 131, a transaction database 132 (or the “Job Model”), and an image database 133 (which may be a content delivery network (CDN)). In one embodiment, the view maker may receive SCP requests from the Appserver 121, and provide instructions rendering SCP according to the request. The transaction database 132 (Job Model) is configured to record the transactions of the different service providers (e.g., transactions between payer of the first service provider and receiver of the second service provider) bridged by the bridging service provider. The image database 133 in the example is a geographically distributed network of proxy servers and their data centers on the cloud configured to provide high availability and performance by distributing the service spatially relative to end users, such as the CDN provided by AWS. The image database may be used to store image resources required to generate confirmation pages. In a case where there are multiple service providers in the bridging network, the image database may store image resources of multiple service providers. The first management system 120 may run two compartments in its system. The first compartment is an off-cloud server running functions of a conventional service provider, such as connecting to the members and executing transactions within the first service provider 12. The second compartment, including the Appserver 121, the push server 122, and the ELB 123, is an on-cloud server configured to connect with the bridging network via the bridging system 130. In this example, the Appserver 121, the push server 122, and the ELB 123 are virtual machines (VM) on the cloud. The user app of the portable device 110 may establish connections to the push server 122 via the first management system 120. In this example, the push server 122 and the ELB 123 serve as intermediate servers between the user app 110 and the Appserver 121 VM. In this way, the Appserver 121 is more secure since this configuration avoids the Appserver 121 from being flooded by data traffic or attacked by malignant users.

After a bridging transaction, the bridging system 130 of the bridging service provider (HIVEX) may push a notification via the first management system 120 of the first service provider to the user (i.e. the payer) 110 of the first service provider, as described in steps S111, S112 and S113 in FIG. 2. In step S111, the first management system (Issuer) 120 of the first service provider receives the confirmation from the bridging system (HIVEX) 130 in its Appserver 121. Then the first management system 120 relays this confirmation to the portable device 110 of the payer via the push server 122 and the off-cloud server (not shown in the figure), as shown in S112 and S113. The functions of a conventional service provider can generate a first confirmation page. For the payer to provide a confirmation page in the format of another service provider (e.g., a second confirmation page in the format of the second service provider), the app installed in the portable device 110 of the payer will request such a confirmation page containing the transaction details and the image format. As shown in FIG. 2, the request along with a user identifier is sent to the off-cloud server of the first management system 120, then an elastic load balancer (ELB) 123 linked with the Appserver 121 of the first service provider (step S121), and then to the Appserver 121 (step S122). The Appserver 121 of the first service provider then relays the request to the view maker 131 of the bridging system 130 (e.g., HIVEX in FIG. 2) (step S123). Upon request, the view maker 131 in the bridging system 130 transmits the user identifier provided by portable device of the payer 110 to the transaction database 132 and retrieves the values recorded on the transaction database 132 (Job Model) (steps S124 and S125). The view maker 131 then returns the contents of a second confirmation page with the format of the second service provider 14 back to the user app 110 based on the user identifier. In this example, the contents of the second confirmation page are generated by the view maker 131 as an HTML file. Based on the user identifier, the bridging system 130 and the first management system 120 can identify the user app 110 logged in with the payer account. The bridging system 130 (HIVEX) then returns the contents of the confirmation page to the user app 110 via the first management system 120 of the first service provider through a reversed route (steps S126, S127 and S128). The user app 110 then may get the image data of the second confirmation page from the image database 124 according to the HTML file, and generate a confirmation page of the second service provider (step S129) based on the contents of the second confirmation page. Depending on the settings and security needs, the image data may be retrieved directly from the Internet (if the image database can be accessed directly from the Internet), or it may be transmitted from the bridging system 130 to the portable device 110 via the first management system 120 with secure transmission. The generated second confirmation page can be shown on the portable device 110 to the merchant for his or her confirmation.

### Dual Confirmation Page and Scalability of the Bridging Network

In the above example, the bridging system 130 provides intact contents of a second confirmation page of the second service provider. The user app 110 only passively receive the contents and retrieve the image resources from the image database to generate a confirmation page according to an HTML file. Therefore, the first service provider needs not to implement any additional systems for DCP generation, except for establishing connections with the bridging system.

Imaging a bridging network with many (e.g., 100) participating service providers. If any of the 100 service providers is configured to generate DCP by its own, the network will need to store 9,900 copies of confirmation page image data of different service providers. And if any one of the participating service providers changes its image format, all other 99 service providers need to update their systems accordingly. Any failure to update in time will result in invalid second confirmation pages. Also, it is hard for the bridging service provider to ensure the correctness of the image resources stored in servers of the participating service providers.

The present invention provides an example where the contents of SCP (including image resources and transaction details) are provided by the bridging system of the bridging service provider. In this way, it is more convenient for the participating service providers to implement their system to realize this functionality. And the contents of generated DCP may also be controlled by the bridging system (which means that a participating service provider will not be able to generate an SCP of any other service provider). There is no need for any service provider to store format contents and image resources related to SCP generation. When the bridging network grows (because more service providers participate in), the participating service providers also need not to change their systems at all.

### DCP Function on a Portable Device

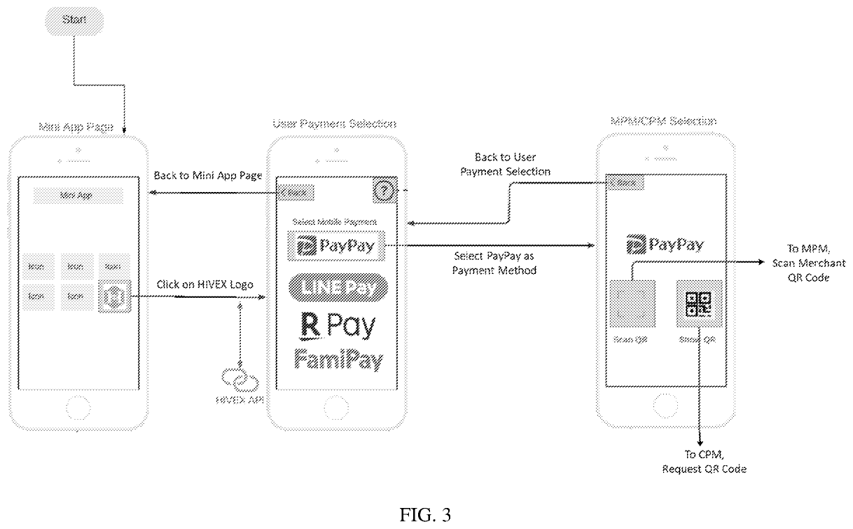

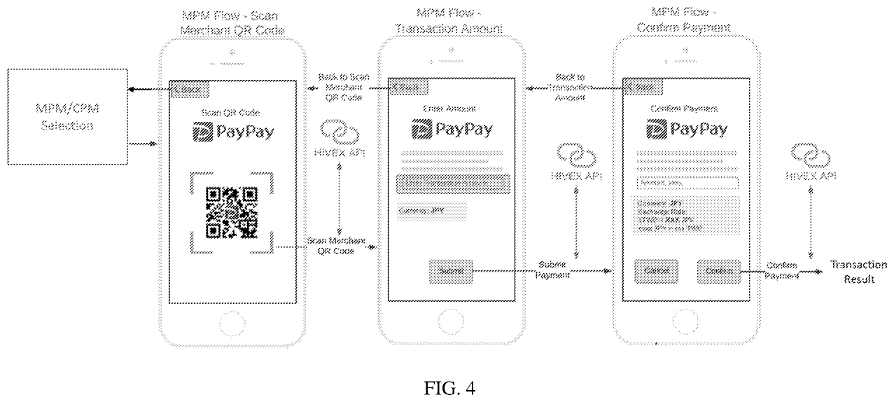

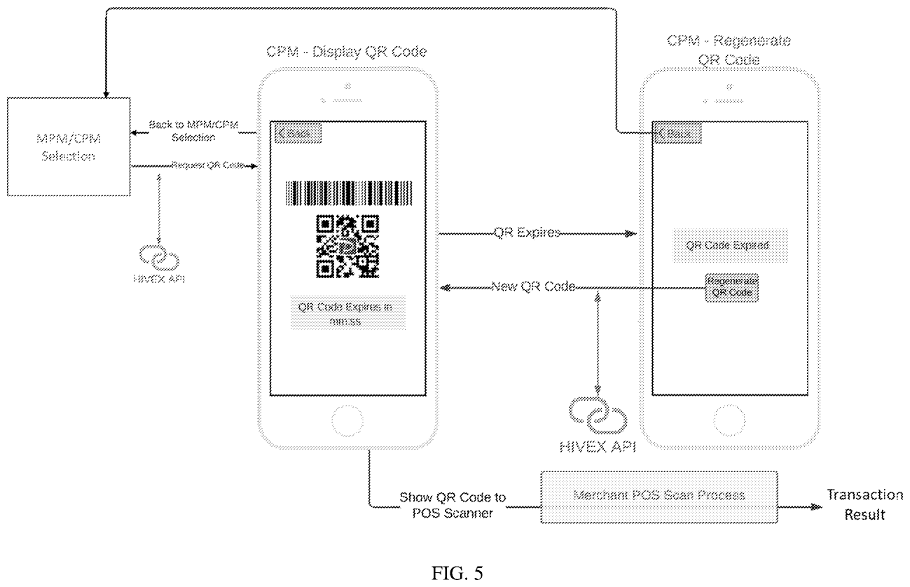

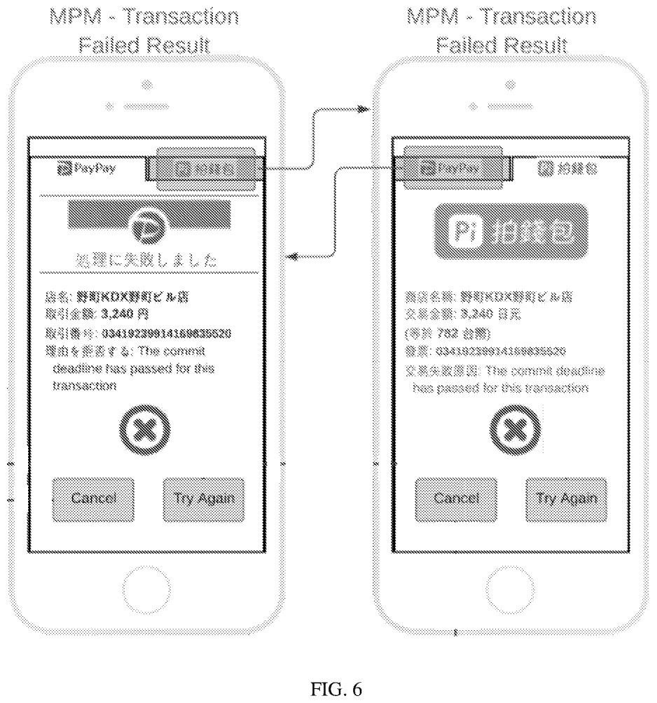

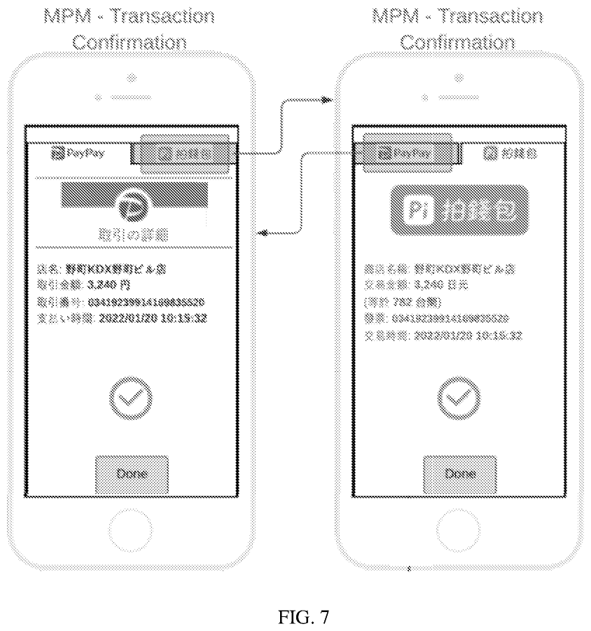

FIG. 3-7 is an example showing how DCP technology works on a portable device. In this example, a user travels to Japan, and would like to pay in a foreign store via mobile payment. The bridging technology has to be employed to enable a transaction between two mobile payment systems. In this example, Pi Wallet is utilized to make the payment (i.e. Pi Wallet serves as the first service provider) and PayPay is selected as the receiver of the payment (i.e. PayPay serves as the second service provider). After selecting PayPay as the second service provider, the app further instructs the user to select payment mode, i.e. consumer presented mode (CPM) or merchant presented mode (MPM), as shown in FIG. 3. In merchant presented mode (MPM), after the user (the payer) enters and confirms the payment amount, the app will go to the transaction result page, as shown in FIG. 4. On the other hand, in the consumer presented mode (CPM), after the merchant scans the bridging QR code, the app will also go to the transaction result page, as shown in FIG. 5. The app shows the dual confirmation page (DCP), no matter the transaction is successful or not. FIG. 6 is the DCP of a failed transaction, and FIG. 7 is the DCP of a successful transaction. The DCP consists of two parts, one is a first confirmation page in the format of the first service provider (Pi Wallet), and the other one is a second confirmation page of the second service provider (PayPay).

For those merchants who are small venders, the merchant showed QR code are usually fixed QR codes, and the POS systems to immediately receive the transaction results are usually absent. With DCP technology, the merchant can confirm the status of the transaction from the consumer even if he or she does not understand the language shown in the confirmation page of the first service provider (which is Chinese in this case). The DCP technology facilitates the cross-border electronic payment by making transaction confirmation much easier.

The foregoing description of embodiments is provided to enable any person skilled in the art to make and use the subject matter. Various modifications to these embodiments will be readily apparent to those skilled in the art, and the novel principles and subject matter disclosed herein may be applied to other embodiments without the use of the innovative faculty. The claimed subject matter set forth in the claims is not intended to be limited to the embodiments shown herein but is to be accorded the widest scope consistent with the principles and novel features disclosed herein. It is contemplated that additional embodiments are within the spirit and true scope of the disclosed subject matter. Thus, it is intended that the present invention covers modifications and variations that come within the scope of the appended claims and their equivalents.

What is claimed is:

1. A method to generate a second confirmation page (SCP) of a second service provider different from a first confirmation page (FCP) of a first service provider for a bridging transaction between a payer of the first service provider and a receiver of the second service provider, comprising:
receiving, by a bridging system of a bridging service provider, a second confirmation page (SCP) request containing a transaction identifier, from a first management system of the first service provider;
searching, by the bridging system, a transaction database for a transaction information corresponding to the transaction identifier;
generating, by the bridging system, an SCP content file containing page layout information for SCP generation; and
providing, by the bridging system, the SCP content file to the first management system;
wherein the first service provider is different from the bridging service provider and the second service provider.

2. The method of claim 1, wherein generating the SCP content file comprises steps of:
identifying, by the bridging service provider, the second service provider from multiple acquirers based on the transaction information; and
generating, by the bridging service provider, the SCP content file of the second service provider.

3. The method of claim 2, wherein the SCP content file comprises a text content and an image reference content.

4. The method of claim 3, after providing the SCP content file to the first management system further comprising:
receiving, by the bridging service provider, an image request for an SCP image content from a portable device of the payer based on the SCP content file; and
providing, by the bridging service provider, the SCP image content to the portable device of the payer.

5. The method of claim 4, wherein the image reference content provides a URL to access the SCP image content.

6. The method of claim 4, wherein the SCP image content is provided from an image database storing image contents of the multiple acquirers.

7. The method of claim 1, wherein the SCP content file comprises an HTML file for generating the SCP.

8. The method of claim 2, wherein the transaction database stores transaction information for transactions between the first service provider and the multiple acquirers.

9. The method of claim 1, wherein the transaction identifier is an identifier recognizable to the bridging system which uniquely identifies the transaction between the payer and the receiver.

10. The method of claim 1, wherein the transaction information corresponding to the transaction identifier comprises a name of the receiver, a transaction number, a transaction time, a transaction currency and a transaction amount.

11. The method of claim 1, wherein the generated second confirmation page (SCP) is displayed on the portable device with the first confirmation page (FCP) generated by the first management system to form dual confirmation page (DCP).

12. The method of claim 11, wherein the dual confirmation page (DCP) has a tab to switch between the first confirmation page (FCP) and the second confirmation page (SCP).

13. A system for generating a second confirmation page (SCP) of a second service provider different from a first confirmation page (FCP) of a first service provider for a bridging transaction between the first service provider and the second service provider which is one of multiple acquirers, comprising:
a transaction database configured to store information of bridging transactions between the first service provider and the multiple acquirers;
an image database configured to store image contents for confirmation pages of the multiple acquirers; and
a view maker communicatively connected to the transaction database, configured to communicatively connect to a first management system of the first service provider;
wherein the view maker comprises instructions stored thereon configured to, in response to execution of the instructions, perform operations comprising:
receiving a second confirmation page (SCP) request containing a transaction identifier, from a first management system of the first service provider;
searching the transaction database for a transaction information corresponding to the transaction identifier;
generating an SCP content file containing page layout information for SCP generation based on the transaction information; and
providing the SCP content file to the first management system;
and wherein the first service provider is different from the second service provider.

14. The system of claim 13, wherein the SCP content file comprises a text content and an image reference content.

15. The system of claim 14, wherein the image reference content provides a URL to access the SCP image content

16. The system of claim 13, wherein the image database is configured to:
receive an image request for an SCP image content from the first management system based on the SCP content file; and
providing the SCP image content to the first management system.

17. The system of claim 13, wherein the SCP content file comprises an HTML file for generating the SCP.

18. The system of claim 13, wherein the view maker is configured to communicatively connect to multiple issuers, one of which is the first management system of the first service provider.

19. The system of claim 13, wherein the transaction identifier is an identifier recognizable to the view maker which uniquely identifies the transaction between a payer of the first service provider and a receiver of the second service provider.

20. The system of claim 13, wherein the transaction information corresponding to the transaction identifier comprises a name of the receiver, a transaction number, a transaction time, a transaction currency and a transaction amount.

21. The system of claim 13, wherein the generated second confirmation page (SCP) is displayed on the portable device with the first confirmation page (FCP) generated by the first management system to form dual confirmation page (DCP).

22. The system of claim 21, wherein the dual confirmation page (DCP) has a tab to switch between the first confirmation page (FCP) and the second confirmation page (SCP).
